(19) United States
(12) Patent Application Publication
(10) Pub. No.: US 2021/0192084 A1
(43) Pub. Date: Jun. 24, 2021

(54) CERTIFICATION AND VALIDATION OF DATA FILES ISSUED BY AN ARCHITECT OR ENGINEER

(71) Applicant: ConcertVDC, Inc., Culver City, CA (US)

(72) Inventor: Adam Wilbrecht, Minneapolis, MN (US)

(21) Appl. No.: 17/121,931

(22) Filed: Dec. 15, 2020

Related U.S. Application Data
(60) Provisional application No. 62/948,715, filed on Dec. 16, 2019.

(51) Int. Cl. G06F 21/64; H04L 9/32; H04L 9/06

(52) U.S. Cl. CPC G06F 21/64; H04L 9/3247; H04L 2209/38; H04L 9/0643; H04L 9/0618

(57) ABSTRACT

A method and system for validating and certifying data files by a professional architect, engineer, land surveyor, landscape architect, geotechnical engineer, interior design, or other professional disciplines related to the design and construction in whole or in part of a building or physical infrastructure. A data file certified under this system will carry the same significance as a physical document signed by analog means or a digital file signed through the use of digital signature technology. Using blockchain encryption a hash is generated for the data file and recorded to a database that may be referenced. Additionally, a blockchain hash is used to authenticate the sovereign identity of the signatory and associates a digital signature and related professional credential to the hash of the associated data file. An indelible timestamp is also created within this process. Upon execution of the signature process the hash of the data file is circulated to either public or private blockchain nodes. Utilizing the ledger functionality of blockchain a successive data files may be established and associated to the blockchain hash of the original file. This registration of the data file with blockchain permits the file to be exchanged freely. At any time the data file may be hashed by the system and referenced to a database. This database will validate the authenticity of the data file as well as identify if the file has been superseded.

### PRIORITY

This application claims the benefit of priority to U.S. Provisional Patent Application Ser. No. 62/948,715, filed Dec. 16, 2019, which is incorporated by reference herein in its entirety.

### TECHNICAL FIELD

This application relates to the field of technological solutions for authoring, storing, amending, certifying and performing other operations on digital assets.

### BACKGROUND

The systems and methods described herein are intended to apply to the professions of architect, engineer, land surveyor, landscape architect, geotechnical engineer, interior design, and other professional disciplines that provide licensed services intended for the construction in whole or in part of a building or of physical infrastructure. Herein to be referred to as “architects and engineers”.

Contemporary architects and engineers are reliant on the exchange of professionally authored data files containing information that communicates the design intent of work to be performed. These data files are typically exchanged with government authorities, construction trades, and other professional agents as needed to perform the work. These data files are typically issued and then iteratively revised to conform to changes in the work or in response to changes dictated by authorized third parties.

As an instrument of professional service there is a need for a technological mechanism to indelibly append a professional certification to these data files. As an intellectual property asset there is a need for a mechanism to register copyright of the digital asset and apply a time stamp with high assurance of authenticity. Additionally, this mechanism must provide a function that when the data file is altered from the original the certification is nullified and disassociated with the data file.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of a system, process and software for use of blockchain on digital assets used in professional services, according to an embodiment.

FIG. 2 illustrates a cloud architecture and flow diagram of the use of blockchain on digital assets used in professional services according to an embodiment.

FIG. 3 is a block diagram illustrating an example of a machine upon which one or more embodiments may be implemented.

### DETAILED DESCRIPTION

There is described herein a technological solution for professional certification and validation of digital data files by a licensed architect or engineer using blockchain technologies.

According to one example embodiment, this technological solution allows professionally authored data files to be digitally certified with a record of the certification memorialized through a cryptographic hash recorded to a distributed ledger and database platformed on blockchain technology. The data file may then be distributed freely with the surety of the file authenticity and provenance is discoverable by a referencing and comparing the blockchain cryptographic hash with the associated database.

According to one example embodiment, this technological solution enables the recipient of a data file to independently verify the authenticity and version history.

According to one example embodiment, this technological solution enables the recipient of a data file to independently verify when which version of the data file was in-force. The identification of a redundant file may have value to determine if a file may be deleted from a system or for establishing which version of the file was in-force when past work was performed.

According to one example embodiment, this technological solution enables the professional to establish a personal digital twin assured by blockchain sovereign identity functions to be used for the purposes of applying a digital certification or signature.

According to one example embodiment, this technological solution enables the professional to certify a data file remotely without having to be the agent that performs the hashing function and distribution of the data file.

According to one example embodiment, this technological solution enables the validation system to be licensed by a third-party document management system to query a database and identify when data files have been superseded.

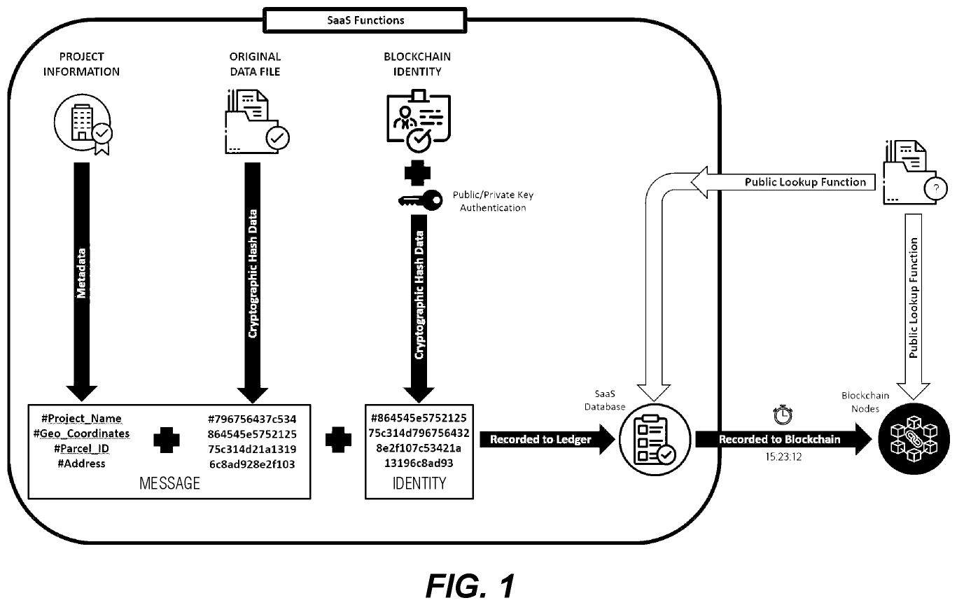

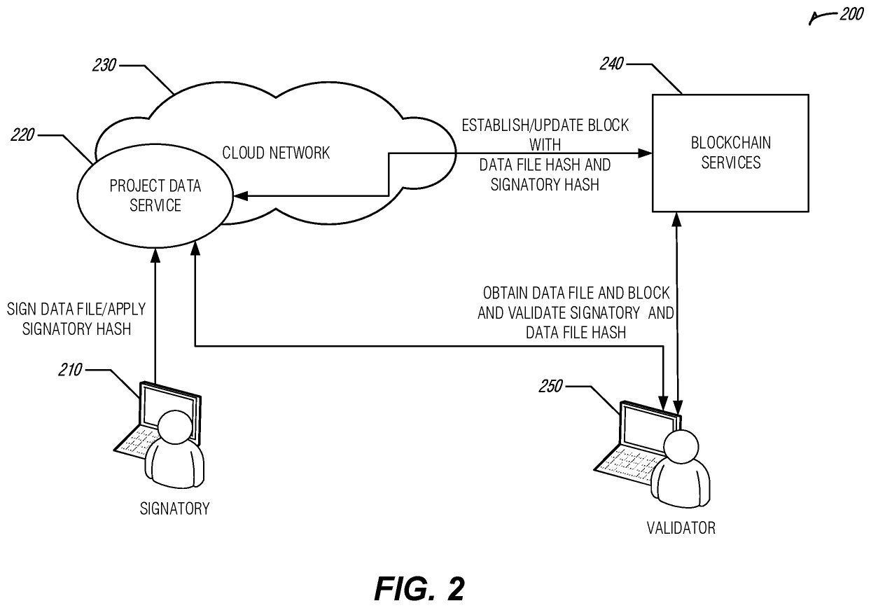

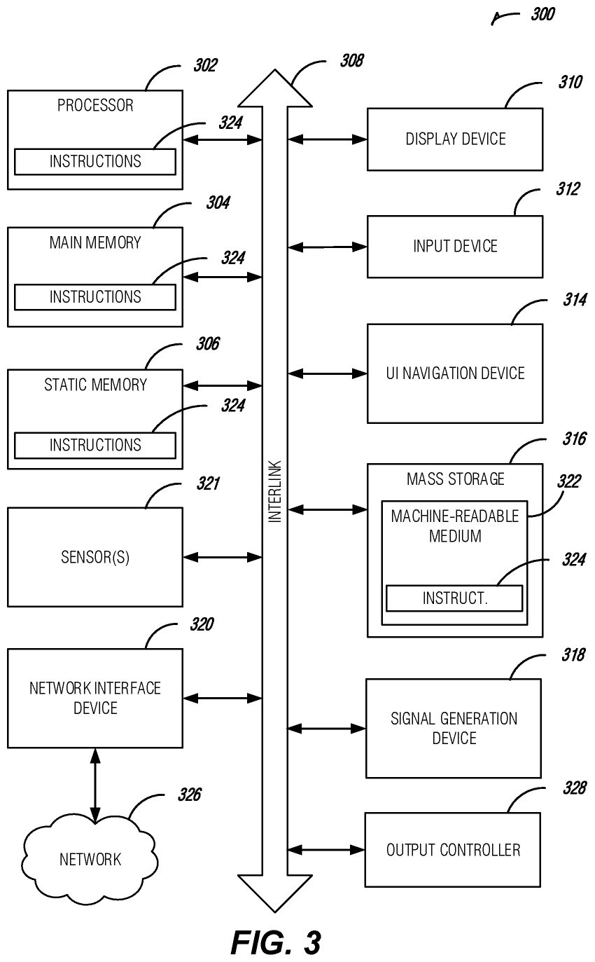

Referring now to FIG. 1, there is illustrated an authoring and recording process and data flow diagram according to one example embodiment. The process illustrated in FIG. 1 is, in one embodiment, performed by one or more computer programs executing on a digital computer, such as a client and/or server computing system, for example as described below with respect to FIGS. 2 and 3. According to another example embodiment, the process of FIG. 1 is deployed in a software-as-a-service (SaaS) architecture.

In step A, a user accesses the SaaS service in the cloud and sets up project information profile and populates this profile with essential metadata to clearly identify the project and its real-world location, owner, and other desired profile data. The generated meta-data is used as component data set.

In step B, following project setup, a user is enabled to input an original data file. This file data is scanned, and a cryptographic hash is generated that is unique to the data file. Examples of such data files include drawings, plans, contracts, proposals, and the like.

In step C, the metadata and the hash data are combined to create a data package, e.g. referred to as a “message”.

In step D, the next input is the identity information for the blockchain. The blockchain is then authenticated, and following authentication of the blockchain, a cryptographic hash of the identity information is generated.

In step E, the generated cryptographic hash of the identity information forms a signature package.

In step F, the information from the data package and the signature package are combined with a mathematical algorithm and recorded to a ledger, for example in one embodiment a localized ledger maintained by the project data service 220 illustrated below in FIG. 2.

In step G, once assembled, the local ledger data is recorded to either a public or private blockchain, such as stored in the blockchain services 240 illustrated in FIG. 2.

According to one embodiment, once the original data file is recorded, succeeding files may be recorded as iterative replacements to the original data file.

According to one embodiment, the lookup process(es) include steps H, J, K and G.

In step H, at any time, a data file held by any user anywhere globally (e.g., the validator 250 illustrated in FIG. 2) may scan and compare a data file against the blockchain ledger through a lookup function. This lookup function will report the project metadata as well as the timestamp and position of the file within the range of the ledger. Conceptually, this will inform the user if the data file they have in their possession is the current file and/or if it carries a signature.

In step J, the lookup function may reference the local database within the SaaS.

In step K, the lookup function may reference the public database of the blockchain.

FIG. 2 illustrates an example deployment 200 of the process of FIG. 1 in the cloud. A client computer 210 accesses a project data service 220 that, in one example embodiment, is deployed as a SaaS on one or more servers in a cloud network 230. The client computer can sign the document and a signatory hash is applied. The project data service 220 accesses blockchain services 240, to record or retrieve information from the blockchain, or other blockchains. Blockchains are established or updated using document hash and signatory hash. The validator 250 retrieves the document from the project data service 220 and the document hash and signatory hash are validated against those stored in a corresponding block to authenticate the signatory and document data.

FIG. 3 illustrates a block diagram of an example machine 300 upon which any one or more of the techniques (e.g., methodologies) discussed herein may perform. For example, machine 300, in one embodiment, is used in a client computer or a server computer in the architecture of FIG. 2 above. In alternative embodiments, the machine 300 may operate as a standalone device or may be connected (e.g., networked) to other machines. In a networked deployment, the machine 300 may operate in the capacity of a server machine, a client machine, or both in server-client network environments. In an example, the machine 300 may act as a peer machine in peer-to-peer (P2P) (or other distributed) network environment. The machine 300 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 300 may include a hardware processor 302 (e.g., a central processing unit (CPU), a graphics processing unit (GPU), a hardware processor core, or any combination thereof), a main memory 304 and a static memory 306, some or all of which may communicate with each other via an interlink (e.g., bus) 308. The machine 300 may further include a display unit 310, an alphanumeric input device 312 (e.g., a keyboard), and a user interface (UI) navigation device 314 (e.g., a mouse). In an example, the display unit 310, input device 312 and UI navigation device 314 may be a touch screen display. The machine 300 may additionally include a storage device (e.g., drive unit) 316, a signal generation device 318 (e.g., a speaker), a network interface device 320, and one or more sensors 321, such as a global positioning system (GPS) sensor, compass, accelerometer, or other sensors. The machine 300 may include an output controller 328, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 316 may include a machine readable medium 322 on which is stored one or more sets of data structures or instructions 324 (e.g., software) embodying or utilized by any one or more of the techniques or functions described herein. The instructions 324 may also reside, completely or at least partially, within the main memory 304, within static memory 306, or within the hardware processor 302 during execution thereof by the machine 300. In an example, one or any combination of the hardware processor 302, the main memory 304, the static memory 306, or the storage device 316 may constitute machine readable media.

While the machine readable medium 322 is illustrated as a single medium, the term “machine readable medium” may include a single medium or multiple media (e.g., a centralized or distributed database, and/or associated caches and servers) configured to store the one or more instructions 324.

The term “machine readable medium” may include any medium that is capable of storing, encoding, or carrying instructions for execution by the machine 300 and that cause the machine 300 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 324 may further be transmitted or received over a communications network 326 using a transmission medium via the network interface device 320 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, etc.), IEEE 802.15.4 family of standards, peer-to-peer (P2P) networks, 3^{rd} Generation Partnership Project (3GPP) standards for 4G and 3G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 320 may include one or more physical jacks (e.g., Ethernet, coaxial, or phone jacks) or one or more antennas to connect to the communications network 326. In an example, the network interface device 320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 300, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A method comprising digitally certifying professionally authored data files with a record of the certification memorialized through a blockchain cryptographic hash recorded to a distributed ledger and database.

2. A method according to claim 1 further comprising distributing the data file with the surety of the file authenticity, wherein a provenance of the file is discoverable by a referencing and comparing the blockchain cryptographic hash with the associated database.

3. A method according to claim 1 further comprising the recipient of a data file independently verifying the authenticity and version history using the blockchain cryptographic hash.

4. A method according to claim 1 further comprising the recipient of a data file to independently verify when which version of the data file was in-force.

5. A method according to claim 1 further comprising establishing a personal digital twin assured by blockchain sovereign identity functions to be used for the purposes of applying a digital certification or signature.

6. A method according to claim 1 further comprising certifying a data file remotely utilizing a blockchain enabled digital twin identity verification without having to be the agent that performs the hashing function and distribution of the data file.

7. A method according to claim 1 further comprising the validation system to be licensed by a third party document management system to query a database and identify when data files have been superseded.

8. A method comprising,
a. a user accessing a software-as-a-service (SaaS) in the cloud and setting up project information profile and populates this profile with essential metadata to clearly identify the project and its real-world location, owner, and other desired profile data;
b. a user inputting an original data file that is scanned and a cryptographic hash is generated that is unique to the data file;
c. combining the metadata and the hash data to create a data package;
d. authenticating the blockchain and generating a cryptographic hash of the identity information, and forming a signature package using the generated cryptographic hash of the identity information;
e. combining the information from the data package and the signature package using a mathematical algorithm and recording the signature package to a ledger; and
f. recording the ledger data to either a public or private blockchain.

9. A method according to claim 8 further comprising:
a. scanning and comparing a data file against the blockchain ledger through a lookup function that reports the project metadata as well as the timestamp and position of the file within the range of the ledger.

10. A method according to claim 9 wherein the lookup function references the public database of the blockchain.
